(19) United States
(12) Patent Application Publication
(10) Pub. No.: US 2025/0192377 A1
(43) Pub. Date: Jun. 12, 2025

(54) TRACTION BATTERY PACKS WITH BATTERY CELL TAB TERMINALS OF A COMMON LENGTH FOR DIRECT WELDING

(71) Applicant: FORD GLOBAL TECHNOLOGIES, LLC, Dearborn, MI (US)

(72) Inventors: Kanchana PERUMALLA, Troy, MI (US); Patrick Daniel MAGUIRE, Ann Arbor, MI (US); Brock DUNLAP, Dearborn, MI (US); Marc DUGAS, Wixom, MI (US); Caleb WANG, Canton, MI (US)

(21) Appl. No.: 18/634,284

(22) Filed: Apr. 12, 2024

Related U.S. Application Data
(60) Provisional application No. 63/607,888, filed on Dec. 8, 2023.

(51) Int. Cl. H01M 50/516; H01M 50/503

(52) U.S. Cl. CPC H01M 50/516; H01M 50/503; H01M 2220/20

(57) ABSTRACT

Techniques are provided for electrically connecting groups of battery cells within a traction battery pack. The battery cells within each groping may include cell tab terminals of a common length for direct welding relative to a cross-member assembly. Groups of cell tab terminals may be received through cell tab openings of the cross-member assembly and then bent into place relative to a backing tab for welding. The cross-member assembly may include various lead-in and bending features that facilitate cell tab terminal bending and welding.

### CROSS-REFERENCE TO RELATED APPLICATIONS

This disclosure claims priority to U.S. Provisional Application No. 63/607,888, which was filed on Dec. 8, 2023 and is incorporated herein by reference in its entirety.

### TECHNICAL FIELD

This disclosure relates generally to traction battery packs, and more particularly to electrically connecting groups of battery cells of a traction battery pack.

### BACKGROUND

Electrified vehicles include a traction battery pack for powering electric machines and other electrical loads of the vehicle. The traction battery pack includes a plurality of battery cells and various other battery internal components that support electric vehicle propulsion.

### SUMMARY

A traction battery pack according to an exemplary aspect of the present disclosure includes, among other things, a cell stack including a first cell packet arranged between a first cross-member assembly and a second cross-member assembly, a first battery cell of the first cell packet including a first cell tab terminal that extends through a first cell tab opening of the first cross-member assembly, and a second battery cell of the first cell packet including a second cell tab terminal that extends through the first cell tab opening of the first cross-member assembly. The first cell tab terminal and the second cell tab terminal include a common length.

In a further non-limiting embodiment of the foregoing traction battery pack, the cell stack further includes a structural thermal barrier assembly located between the first cell packet and a second cell packet that is arranged between the first cross-member assembly and the second cross-member assembly.

In a further non-limiting embodiment of either of the foregoing traction battery packs, a third battery cell of the second cell packet includes a third cell tab terminal that extends through a second cell tab opening of the first cross-member assembly, and a fourth battery cell of the second cell packet includes a fourth cell tab terminal that extends through the second cell tab opening of the first cross-member assembly.

In a further non-limiting embodiment of any of the foregoing traction battery packs, a gap extends between tip portions of the first and second cell tab terminals and tip portions of the third and fourth cell tab terminals.

In a further non-limiting embodiment of any of the foregoing traction battery packs, a first weld bead joins the tip portions of the first and second cell tab terminals, and a second weld bead joins the tip portions of the third and fourth cell tab terminals.

In a further non-limiting embodiment of any of the foregoing traction battery packs, the first weld bead and the second weld bead each establish a 3-way joint for joining the tip portions of the first and second cell tab terminals and the tip portions of the third and fourth cell tab terminals to a backing tab of the first cross-member assembly.

In a further non-limiting embodiment of any of the foregoing traction battery packs, tip portions of the first and second cell tab terminals and tip portions of the third and fourth cell tab terminals overlap one another and are received at a position adjacent to a backing tab of the first cross-member assembly.

In a further non-limiting embodiment of any of the foregoing traction battery packs, the backing tab establishes a backing surface for joining the tip portions together.

In a further non-limiting embodiment of any of the foregoing traction battery packs, a first weld bead joins the tip portions of the first and second cell tab terminals and the tip portions of the third and fourth cell tab terminals together.

In a further non-limiting embodiment of any of the foregoing traction battery packs, the first weld bead establishes a 5-way joint for joining the tip portions of the first and second cell tab terminals and the tip portions of the third and fourth cell tab terminals to the backing tab.

In a further non-limiting embodiment of any of the foregoing traction battery packs, the first cell tab terminal overlaps the second cell tab terminal on an opposite side of the first cross-member assembly from a respective housing of each of the first and second battery cells.

In a further non-limiting embodiment of any of the foregoing traction battery packs, the first cross-member assembly includes a ladder frame, a first pultruded reinforcement beam that is mounted to the ladder frame, and a second pultruded reinforcement beam that is mounted to the ladder frame.

In a further non-limiting embodiment of any of the foregoing traction battery packs, the first cell tab opening is formed through the ladder frame at a location between the first reinforcement beam and the second reinforcement beam.

In a further non-limiting embodiment of any of the foregoing traction battery packs, the first cell tab opening is circumscribed by a radiused edge of a ladder frame of the first cross-member assembly. The radiused edge includes a bending surface configured for bending the first and second cell tab terminals into a bent position relative to the ladder frame.

In a further non-limiting embodiment of any of the foregoing traction battery packs, the first cross-member assembly includes a mandrel arranged for bending the first and second cell tab terminals into a bent position relative to a ladder frame of the first cross-member assembly.

A traction battery pack according to another exemplary aspect of the present disclosure includes, among other things, a first cell packet including a first battery cell and a second battery cell, and a second cell packet including a third battery cell and a fourth battery cell. A structural thermal barrier assembly is arranged between the first cell packet and the second cell packet. A cross-member assembly is arranged to interface with each of the first cell packet, the second cell packet, and the structural thermal barrier assembly. A first cell tab terminal of the first battery cell and a second cell tab terminal of the second battery cell extend through a first cell tab opening of the cross-member assembly and are bent against a backing tab of the cross-member assembly. A third cell tab terminal of the third battery cell and a fourth cell tab terminal of the fourth battery cell extend through a second cell tab opening of the cross-member assembly and are bent against the backing tab.

In a further non-limiting embodiment of the foregoing traction battery pack, each of the first cell tab terminal, the second cell tab terminal, the third cell tab terminal, and the fourth cell tab terminal include a common length.

In a further non-limiting embodiment of either of the foregoing traction battery packs, a gap extends between tip portions of the first and second cell tab terminals and tip portions of the third and fourth cell tab terminals.

In a further non-limiting embodiment of any of the foregoing traction battery packs, tip portions of the first and second cell tab terminals and tip portions of the third and fourth cell tab terminals overlap one another at a position over the backing tab.

In a further non-limiting embodiment of any of the foregoing traction battery packs, at least one weld bead joins the first cell tab terminal, the second cell tab terminal, the third cell tab terminal, and the fourth cell tab terminal to the backing tab.

The embodiments, examples, and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

The various features and advantages of this disclosure will become apparent to those skilled in the art from the following detailed description. The drawings that accompany the detailed description can be briefly described as follows.

### BRIEF DESCRIPTION OF THE DRAWINGS

FIG. 1 schematically illustrates an electrified vehicle.

FIG. 2 is an exploded perspective view of a traction battery pack for an electrified vehicle.

FIG. 3 illustrates an exemplary battery cell of a traction battery pack.

FIG. 4 illustrates select portions of a cell stack of a traction battery pack.

FIG. 5 is a cross-sectional view through section 5-5 of FIG. 4.

FIG. 6 illustrates an exemplary weld joint of a plurality of cell tab terminals from adjacent cell packets of a traction battery cell stack.

FIG. 7 illustrates exemplary cell tab terminal lead-in and bending features of a cross-member assembly of a traction battery cell stack.

FIG. 8 illustrates exemplary cell tab terminal bending features of another cross-member assembly of a traction battery cell stack.

### DETAILED DESCRIPTION

This disclosure details techniques for electrically connecting groups of battery cells within a traction battery pack. The battery cells within each groping may include cell tab terminals of a common length for direct welding relative to a cross-member assembly. Groups of cell tab terminals may be received through cell tab openings of the cross-member assembly and then bent into place relative to a backing tab for welding. The cross-member assembly may include various lead-in and bending features that facilitate cell tab terminal bending and welding. These and other features are discussed in greater detail in the following paragraphs of this detailed description.

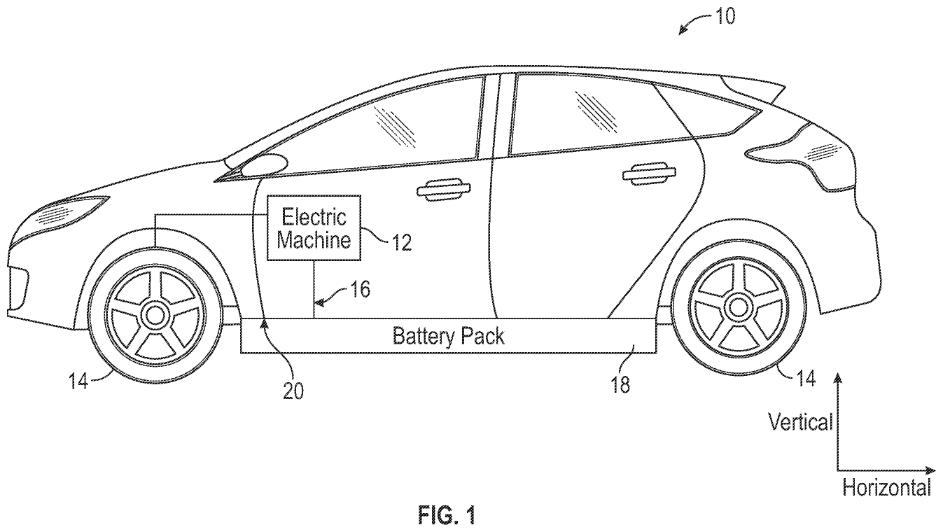

FIG. 1 schematically illustrates an electrified vehicle 10. The electrified vehicle 10 may include any type of electrified powertrain. In an embodiment, the electrified vehicle 10 is a battery electric vehicle (BEV). However, the concepts described herein are not limited to BEVs and could extend to other electrified vehicles, including, but not limited to, hybrid electric vehicles (HEVs), plug-in hybrid electric vehicles (PHEV's), fuel cell vehicles, etc. Therefore, although not specifically shown in the exemplary embodiment, the powertrain of the electrified vehicle 10 could be equipped with an internal combustion engine that can be employed either alone or in combination with other power sources to propel the electrified vehicle 10.

In the illustrated embodiment, the electrified vehicle 10 is depicted as a car. However, the electrified vehicle 10 could alternatively be a sport utility vehicle (SUV), a van, a pickup truck, or any other vehicle configuration. Although a specific component relationship is illustrated in the figures of this disclosure, the illustrations are not intended to limit this disclosure. The placement and orientation of the various components of the electrified vehicle 10 are shown schematically and could vary within the scope of this disclosure. In addition, the various figures accompanying this disclosure are not necessarily drawn to scale, and some features may be exaggerated or minimized to emphasize certain details of a particular component, assembly, or system.

In the illustrated embodiment, the electrified vehicle 10 is a full electric vehicle propelled solely through electric power, such as by one or more electric machines 12, without assistance from an internal combustion engine. The electric machine 12 may operate as an electric motor, an electric generator, or both. The electric machine 12 receives electrical power and can convert the electrical power to torque for driving one or more wheels 14 of the electrified vehicle 10.

A voltage bus 16 may electrically couple the electric machine 12 to a traction battery pack 18. The traction battery pack 18 is an exemplary electrified vehicle battery. The traction battery pack 18 may be a high voltage traction battery pack assembly that includes a plurality of battery cells capable of outputting electrical power to power the electric machine 12 and/or other electrical loads of the electrified vehicle 10. Other types of energy storage devices and/or output devices could alternatively or additionally be used to electrically power the electrified vehicle 10.

The traction battery pack 18 may be secured to an underbody 20 of the electrified vehicle 10. However, the traction battery pack 18 could be located elsewhere on the electrified vehicle 10 within the scope of this disclosure.

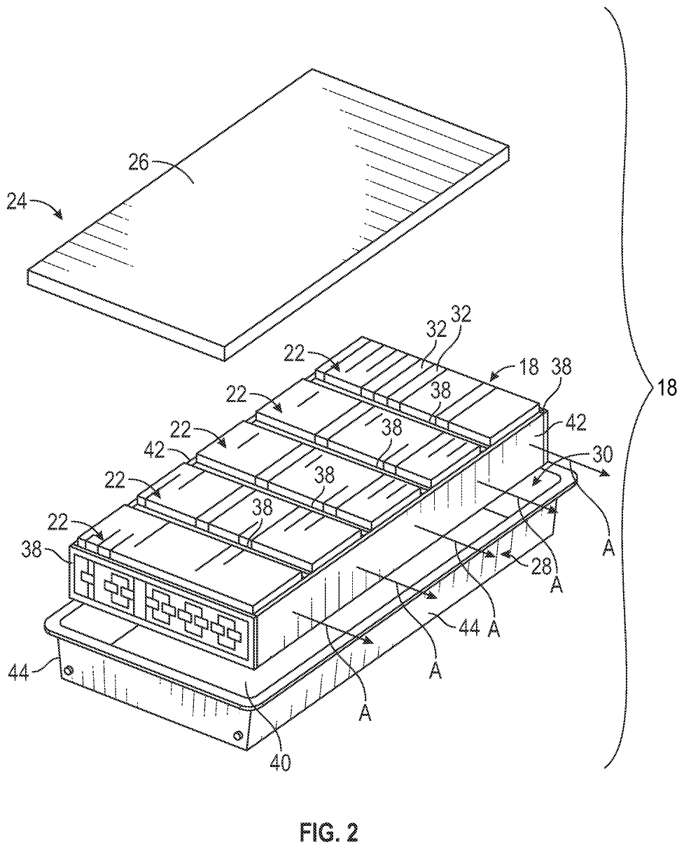

FIG. 2 illustrates additional details associated with the traction battery pack 18 of the electrified vehicle 10 of FIG. 1. The traction battery pack 18 may include a plurality of cell stacks 22 housed within an interior area 30 of an enclosure assembly 24. The enclosure assembly 24 of the traction battery pack 18 may include an enclosure cover 26 and an enclosure tray 28. The enclosure cover 26 may be secured (e.g., bolted, welded, adhered, etc.) to the enclosure tray 28 to provide the interior area 30 for housing the cell stacks 22 and other battery internal components of the traction battery pack 18.

Each cell stack 22 may include a plurality of battery cells 32. The battery cells 32 of each cell stack 22 may be stacked together side-by-side along a cell stack axis A. The battery cells 32 store and supply electrical power for powering various components of the electrified vehicle 10. Although a specific number of the cell stacks 22 and battery cells 32 are illustrated in the various figures of this disclosure, the traction battery pack 18 could include any number of the cell stacks 22, with each cell stack 22 having any number of individual battery cells 32.

In an embodiment, the battery cells 32 are lithium-ion pouch cells. However, battery cells having other geometries (cylindrical, prismatic, etc.) and/or chemistries (nickel-metal hydride, lead-acid, etc.) could alternatively be utilized within the scope of this disclosure.

As further detailed below, the battery cells 32 include tab terminals that project outwardly from a battery cell housing. The tab terminals of the battery cells 32 of each cell stack 22 are connected to one another, such as by one or more busbars, for example, in order to provide the voltage and power levels necessary for achieving vehicle propulsion.

The battery cells 32 of each cell stack 22 may be arranged between a pair of cross-member assemblies 38. Among other functions, the cross-member assemblies 38 may be configured to hold the battery cells 32 and at least partially delineate the cell stacks 22 from one another within the interior area 30 of the enclosure assembly 24.

Each cross-member assembly 38 may be configured to transfer a load applied to a side of the electrified vehicle 10, for example, for ensuring that the battery cells 32 do not become overcompressed. Each cross-member assembly 38 may be further configured to accommodate tension loads resulting from expansion and retraction of the battery cells 32. The cross-member assemblies 38 described herein are therefore configured to increase the structural integrity of the traction battery pack 18.

A vertically upper side of each cell stack 22 may interface with the enclosure cover 26, and a vertically lower side of each cell stack 22 may interface with a heat exchanger plate 40 that is positioned against a floor of the enclosure tray 28. In another embodiment, the heat exchanger plate 40 may be omitted and the vertically lower side of each cell stack 22 may be received in direct contact with the floor of the enclosure tray 28. Vertical and horizontal, for purposes of this disclosure, are with reference to ground and a general orientation of traction battery pack 18 when installed within the electrified vehicle 10 of FIG. 1.

The cross-member assemblies 38 may be adhesively secured to the enclosure cover 26 (or an intermediate structure) and to either the heat exchanger plate 40 or the enclosure tray 28 to seal the interfaces between these neighboring components and to structurally integrate the traction battery pack 18.

The cell stacks 22 may be arranged to extend along their respective cell stack axes A between opposing end plates 42. One or more end plates 42 may be positioned between each end of each cell stack 22 and a longitudinally extending side wall 44 of the enclosure tray 28. The end plates 42 may therefore extend along axes that are substantially transverse (e.g. perpendicular) to the cell stack axes A of the cell stacks 22 and the cross-member assemblies 38. In some implementations, the end plates 42 are structural members that span across a majority of the length of the longitudinally extending side wall 44 of the enclosure tray 28. However, other configurations are contemplated within the scope of this disclosure.

In an embodiment, the cell stacks 22 and the cross-member assemblies 38 extend longitudinally in a cross-vehicle direction of the electrified vehicle 10, and the end plates 42 extend longitudinally in a length-wise direction of the electrified vehicle 10. However, other configurations are contemplated within the scope of this disclosure.

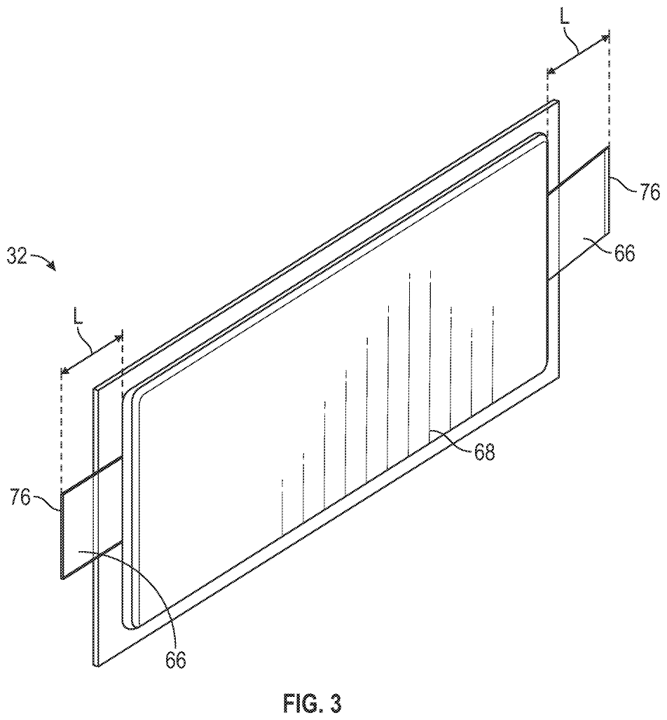

FIG. 3 illustrates one of the battery cells 32 that can be provided within the traction battery pack 18. Each battery cell 32 may include a housing 68 and a pair of tab terminals 66 that project outwardly from the housing 68. In an embodiment, each battery cell 32 includes two cell tab terminals 66, with one tab terminal 66 protruding outwardly at each opposing side of the housing 68. One of the cell tab terminals 66 may provide the positive terminal of the battery cell 32, and the other cell tab terminal 66 may provide the negative terminal of the battery cell 32. However, other configurations are further contemplated within the scope of this disclosure.

The cell tab terminals 66 of each battery cell 32 included within each cell stack 22 of the traction battery pack 18 may be maintained at a common cell tab length L, thus reducing cell tab complexity. The cell tab length L is the distance each tab terminal 66 extends between the housing 68 and a tip portion 76 of the cell tab terminal 66.

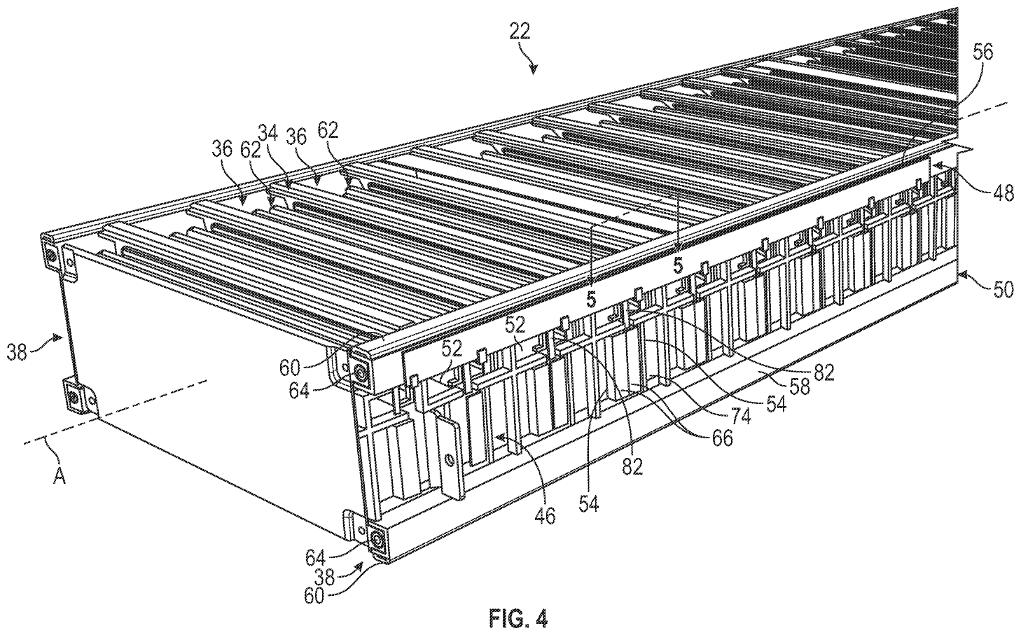

Referring now to FIGS. 4 and 5 with continued reference to FIGS. 1-3, the battery cells 32 of each cell stack 22 may be arranged to extend between a pair of the cross-member assemblies 38. Each cross-member assembly 38 of the traction battery pack 18 may include a ladder frame 46 and one or more reinforcement sections. In the illustrated embodiment, the cross-member assembly 38 includes an upper or first reinforcement beam 48 and a lower or second reinforcement beam 50. However, other configurations are also contemplated within the scope of this disclosure.

The first reinforcement beam 48 and the second reinforcement beam 50 may be mounted at separate locations of the ladder frame 46 for structurally reinforcing the cross-member assembly 38. The ladder frame 46 and the first and second reinforcement beams 48, 50 may include mateable features that facilitate the connection of the first and second reinforcement beams 48, 50 to the ladder frame 46.

In an embodiment, the first and second reinforcement beams 48, 50 are pultrusions, which implicates structure to these beam-like structures. A person of ordinary skill in the art having the benefit of this disclosure would understand how to structurally distinguish a pultruded beam structure from another type of structure, such as an extruded beam, for example.

The first and second first reinforcement beams 48, 50 may be manufactured as part of a pultrusion process that utilizes a glass or carbon fiber (unidirectional or multidirectional mat) and a thermoset resin. A plurality of glass or carbon fiber strands may be pulled through the thermoset resin as part of the pultrusion process for manufacturing the first and second first reinforcement beams 48, 50.

When mounted to the ladder frame 46, the first reinforcement beam 48 may establish an upper plateau 56 of the cross-member assembly 38, and the second reinforcement beam 50 may establish a lower base 58 of the cross-member assembly 38. An adhesive 60 may be applied to the upper plateau 56 and/or to the lower base 58 for securing the cross-member assembly 38 directly to the enclosure cover 26 and/or to either the heat exchanger plate 40 or the enclosure tray 28, respectively. The cell stacks 22 may therefore be structurally integrated with the enclosure assembly 24 of the traction battery pack 18.

The cross-member assembly 38 may include one or more fastener openings 64 for securing the cross-member assembly 38, and thus the cell stack 22, to a neighboring structure, such as one of the end plates 42 of the traction battery pack 18 shown in FIG. 2, for example. The fastener openings 64 may be formed in the ladder frame 46 or provided by separate caps or fastener housings that are connected to either the ladder frame 46 or one or both of the first and second reinforcement beams 48, 50.

Each fastener opening 64 is configured to receive a fastener (e.g., bolt, screw, etc.). The fastener (not shown) may be passed through the end plate 42 and then be accommodated within one of the fastener openings 64 for mounting the cell stack 22 to the end plate 42. This connection can help contain tensile loads that can occur over the life of the cell stack 22 as a result of battery cell expansion forces while also allowing for side forces to be distributed over a larger area when compressive forces act on the traction battery pack along the direction of the cell stack axis A.

The ladder frame 46 may be either a unitary or a multi-piece injection molded structure. The ladder frame 46 may be made of any suitable thermoplastic material.

The ladder frame 46 may include one or more vent openings 52 and cell tab openings 54. In an assembled state of the cross-member assembly 38, both the vent openings 52 and the cell tab openings 54 are located between the first and second reinforcement beams 48, 50. However, other configurations are possible within the scope of this disclosure.

The vent openings 52 are configured for communicating battery cell vent byproducts through the ladder frame 46 and into a passageway located between adjacent cell stacks 22. The vent openings 52 may thus provide a pathway for battery cell vent byproducts to move through the cross-member assembly 38 as may be required during a cell venting event, for example.

The cell tab openings 54 may be arranged vertically below the vent openings 52. The cell tab openings 54 may be elongated slots configured to accommodate the cell tab terminals 66 of the battery cells 32. In an embodiment, each cell tab opening 54 may be sized to receive two or more cell tab terminals 66 from multiple adjacent battery cells 32. Therefore, the total number of cell tab openings 54 required to be provided within the ladder frame 46 for accommodating the cell tab terminals 66 can be reduced, thereby simplifying manufacturing and increasing the overall stiffness of the cross-member assembly 38.

One or more structural thermal barrier assemblies 34 may be arranged along the respective cell stack axis A of each cell stack 22. The structural thermal barrier assemblies 34 may compartmentalize each cell stack 22 into two or more groupings or compartments 36 of battery cells 32.

A cell packet 62 may be positioned within each compartment 36 of the cell stack 22. Each cell packet 62 may be separated from a neighboring cell packet 62 by one of the structural thermal barrier assemblies 34. Each cell packet 62 may include a plurality of battery cells 32 and a cell expansion pad 70 (best shown in FIG. 5) arranged between neighboring battery cells 32 within the cell packet 62. The cell expansion pads 70 may include a material(s) (e.g., polyurethane foam, silicone foam, etc.) adapted for accommodating battery cell swelling.

Cell tab terminals 66 of two or more battery cells 32 of each cell packet 62 may be passed through one of the cell tab openings 54 and then folded over a backing tab 72 that is connected to the ladder frame 46. In an embodiment, the backing tab 72 is a metallic (e.g., copper or aluminum) component that is secured to a wall portion 74 of the ladder frame 46 that extends between two neighboring cell tab openings 54 associated with adjacent cell packets 62 of the cell stack 22. Each backing tab 72 may provide a suitable backing surface for joining (e.g., welding) the cell tab terminals 66 together in order to electrically connect the battery cells 32 of the cell packets 62.

Each backing tab 72 may additionally provide a sense lead 82 (see FIG. 4) that can be used to collect data. For example, a voltage of the cell tab terminals 66 of the battery cells 32 of each cell packet 62 may be monitored and collected by the backing tab 72 and its integrated sense lead 82.

To electrically connect the cell tab terminals 66 within each cell stack 22, groups of cell tab terminals 66 from each cell packet 62 may be extended through their respective cell tab openings 54 and then folded over one of the backing tabs 72 such that the cell tab terminals 66 overlap one another. When folded, the cell tab terminals 66 are located on an opposite side of the cross-member assembly 38 from the housings 68 of the battery cells 32. Since each cell tab terminal 66 is of a common length across the entire cell stack 22, tip portions 76 of the overlapping cell tab terminals 66 may be spaced apart from one another (see FIG. 5) and therefore are not directly aligned when moved to the folded position of the cell tab terminals 66. However, other configurations are contemplated within the scope of this disclosure.

In an embodiment, a gap 78 extends between the overlapping cell tab terminals 66 of battery cells 32 located within adjacent cell packets 62 of the cell stack 22. A weld bead 80 (see FIG. 5), such as that created during a laser welding process, for example, may then be applied to the overlapped cell tab terminals 66 for electrically connecting the cell tab terminals 66 of battery cell groupings from each cell packet 62. In this implementation, since the overlapping cell tab terminals 66 of battery cells 32 from adjacent cell packets 62 do not overlap one another on the shared backing tab 72, each weld bead 80 is configured as a 3-layer joint that joins two overlapping cell tab terminals 66 and the backing tab 72.

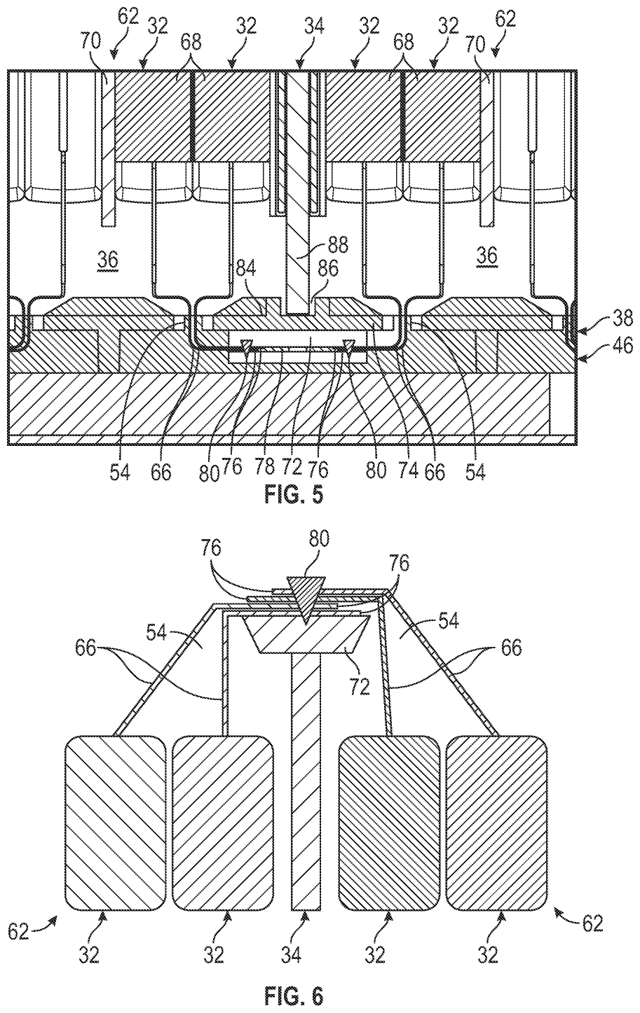

In another embodiment, the cell tab terminals 66 of battery cells 32 located within adjacent cell packets 62 of the cell stack 22 may all overlap one another when folded over the shared backing tab 72 (see, e.g., FIG. 6). In this implementation, the weld bead 80 is configured as a 5-layer joint that joins the four overlapping cell tab terminals 66 and the backing tab 72.

An inside surface 84 of the wall portion 74 of the cross-member assembly 38 may interface with the structural thermal barrier assembly 34 that separates adjacent cell packets 62 of the cell stack 22. For example, as best shown in FIG. 5, the inside surface 84 may include a C-channel 86 that is sized to accommodate an end portion 88 of the structural thermal barrier assembly 34. Together, the end portion 88 and the C-channel 86 may establish a tongue-and-groove connection between the structural thermal barrier assembly 34 and the cross-member assembly 38.

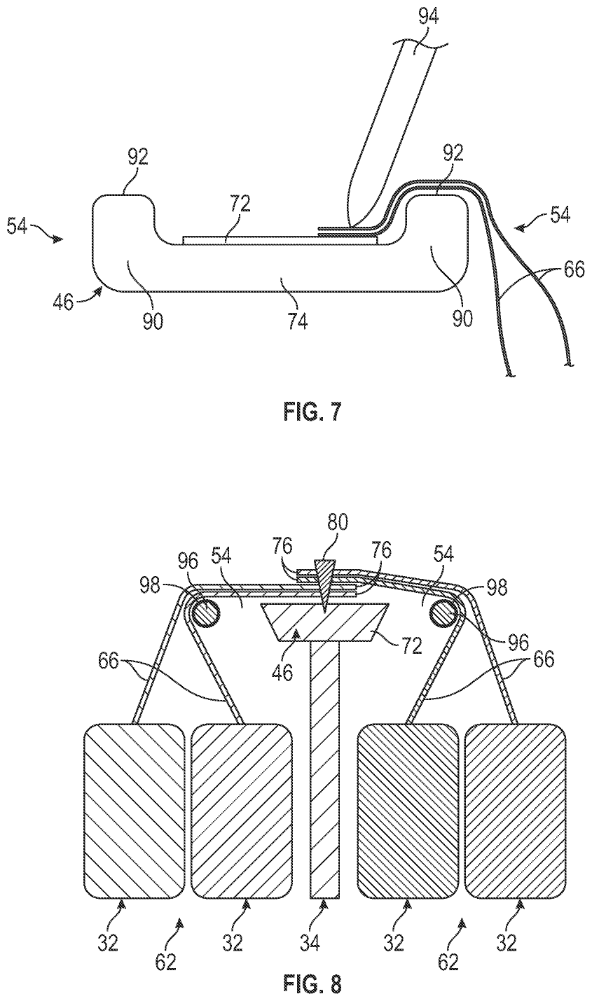

Referring now to FIG. 7, the cell tab openings 54 of the ladder frame 46 may be circumscribed by radiused edges 90 that connect to the wall portions 74 of the ladder frame 46. The radiused edges 90 provide lead-in features for accommodating the cell tab terminals 66 through the cell tab openings 54. The radiused edges 90 may further provide a bending surface 92 that can be used to bend pairs of cell tab terminals 66 together into place against one of the backing tabs 72. A bending tool 94 may be used to bend the cell tab terminals 66 over the bending surfaces 92 and into a welding position against the backing tabs 72.

In another implementation, shown in FIG. 8, the ladder frame 46 of the cross-member assembly 38 may include integrated mandrels 96 that can facilitate bending of the cell tab terminals 66 after being received through the cell tab openings 54. Alternatively, the mandrels 96 may be part of assembly tooling that is separate from the cross-member assembly 38.

Each mandrel 96 may be positioned such that a wrap radius 98 provided by the mandrel 96 is about equidistant between the two battery cells 32 of the cell packet 62 that is closest to the mandrel 96. In this way, the tip portions 76 of the overlapping cell tab terminals 66 may be directly aligned with one another without the need for trimming when moved to the folded position of the cell tab terminals 66. The tip portions 76 can then be joined together and to the backing tab 72 by one or more weld beads 80.

The traction battery packs of this disclosure include battery cells of reduced complexity by incorporating cell tab terminals of a common length. Two or more cell tab terminals may be passed through a shared cross-member assembly cell tab opening, thereby reducing number of required openings for receiving the cell tab terminals and thus increasing cross-member assembly stiffness. Cell tab terminal welding is simplified by allowing the cell tab terminals to be bent and welded together against a common backing tab in either overlapping or non-overlapping configurations.

Although the different non-limiting embodiments are illustrated as having specific components or steps, the embodiments of this disclosure are not limited to those particular combinations. It is possible to use some of the components or features from any of the non-limiting embodiments in combination with features or components from any of the other non-limiting embodiments.

It should be understood that like reference numerals identify corresponding or similar elements throughout the several drawings. It should be understood that although a particular component arrangement is disclosed and illustrated in these exemplary embodiments, other arrangements could also benefit from the teachings of this disclosure.

The foregoing description shall be interpreted as illustrative and not in any limiting sense. A worker of ordinary skill in the art would understand that certain modifications could come within the scope of this disclosure. For these reasons, the following claims should be studied to determine the true scope and content of this disclosure.

What is claimed is:

1. A traction battery pack, comprising:
a cell stack comprising a first cell packet arranged between a first cross-member assembly and a second cross-member assembly;
a first battery cell of the first cell packet including a first cell tab terminal that extends through a first cell tab opening of the first cross-member assembly; and
a second battery cell of the first cell packet including a second cell tab terminal that extends through the first cell tab opening of the first cross-member assembly,
wherein the first cell tab terminal and the second cell tab terminal include a common length.

2. The traction battery pack as recited in claim 1, wherein the cell stack further includes a structural thermal barrier assembly located between the first cell packet and a second cell packet that is arranged between the first cross-member assembly and the second cross-member assembly.

3. The traction battery pack as recited in claim 2, wherein a third battery cell of the second cell packet includes a third cell tab terminal that extends through a second cell tab opening of the first cross-member assembly, and a fourth battery cell of the second cell packet includes a fourth cell tab terminal that extends through the second cell tab opening of the first cross-member assembly.

4. The traction battery pack as recited in claim 3, wherein a gap extends between tip portions of the first and second cell tab terminals and tip portions of the third and fourth cell tab terminals.

5. The traction battery pack as recited in claim 4, comprising a first weld bead that joins the tip portions of the first and second cell tab terminals, and a second weld bead that joins the tip portions of the third and fourth cell tab terminals.

6. The traction battery pack as recited in claim 5, wherein the first weld bead and the second weld bead each establish a 3-way joint for joining the tip portions of the first and second cell tab terminals and the tip portions of the third and fourth cell tab terminals to a backing tab of the first cross-member assembly.

7. The traction battery pack as recited in claim 3, wherein tip portions of the first and second cell tab terminals and tip portions of the third and fourth cell tab terminals overlap one another and are received at a position adjacent to a backing tab of the first cross-member assembly.

8. The traction battery pack as recited in claim 7, wherein the backing tab establishes a backing surface for joining the tip portions together.

9. The traction battery pack as recited in claim 7, comprising a first weld bead that joins the tip portions of the first and second cell tab terminals and the tip portions of the third and fourth cell tab terminals together.

10. The traction battery pack as recited in claim 9, wherein the first weld bead establishes a 5-way joint for joining the tip portions of the first and second cell tab terminals and the tip portions of the third and fourth cell tab terminals to the backing tab.

11. The traction battery pack as recited in claim 1, wherein the first cell tab terminal overlaps the second cell tab terminal on an opposite side of the first cross-member assembly from a respective housing of each of the first and second battery cells.

12. The traction battery pack as recited in claim 1, wherein the first cross-member assembly includes a ladder frame, a first pultruded reinforcement beam that is mounted to the ladder frame, and a second pultruded reinforcement beam that is mounted to the ladder frame.

13. The traction battery pack as recited in claim 12, wherein the first cell tab opening is formed through the ladder frame at a location between the first reinforcement beam and the second reinforcement beam.

14. The traction battery pack as recited in claim 1, wherein the first cell tab opening is circumscribed by a radiused edge of a ladder frame of the first cross-member assembly, and further wherein the radiused edge includes a bending surface configured for bending the first and second cell tab terminals into a bent position relative to the ladder frame.

15. The traction battery pack as recited in claim 1, wherein the first cross-member assembly includes a mandrel arranged for bending the first and second cell tab terminals into a bent position relative to a ladder frame of the first cross-member assembly.

16. A traction battery pack, comprising:
a first cell packet including a first battery cell and a second battery cell;
a second cell packet including a third battery cell and a fourth battery cell;
a structural thermal barrier assembly arranged between the first cell packet and the second cell packet;
a cross-member assembly arranged to interface with each of the first cell packet, the second cell packet, and the structural thermal barrier assembly;
a first cell tab terminal of the first battery cell and a second cell tab terminal of the second battery cell extending through a first cell tab opening of the cross-member assembly and bent against a backing tab of the cross-member assembly; and
a third cell tab terminal of the third battery cell and a fourth cell tab terminal of the fourth battery cell extending through a second cell tab opening of the cross-member assembly and bent against the backing tab.

17. The traction battery pack as recited in claim 16, wherein each of the first cell tab terminal, the second cell tab terminal, the third cell tab terminal, and the fourth cell tab terminal include a common length.

18. The traction battery pack as recited in claim 16, wherein a gap extends between tip portions of the first and second cell tab terminals and tip portions of the third and fourth cell tab terminals.

19. The traction battery pack as recited in claim 16, wherein tip portions of the first and second cell tab terminals and tip portions of the third and fourth cell tab terminals overlap one another at a position over the backing tab.

20. The traction battery pack as recited in claim 16, comprising at least one weld bead for joining the first cell tab terminal, the second cell tab terminal, the third cell tab terminal, and the fourth cell tab terminal to the backing tab.
